(19) United States
(12) Patent Application Publication
(10) Pub. No.: US 2006/0038021 A1
(43) Pub. Date: Feb. 23, 2006

(54) METHOD AND APPARATUS FOR READING BAR CODE SYMBOLS

(76) Inventors: Jay S. Cantwell, St. Charles, MO (US); Zeke A. Homes, St. Peters, MO (US)

Correspondence Address: Jay S. Cantwell, 1803 Beltway, St. Louis, MO, 63114, US

(21) Appl. No.: 10/922,171

(22) Filed: Aug. 20, 2004

(51) Int. Cl. G06K 19/00; G06K 7/10

(52) U.S. Cl. 235/487; 235/462.01

(57) ABSTRACT

A method of making a machine readable data symbol marking on an article to be marked is disclosed. The symbol is marked on the article using a stain. The stain includes particles of conductive materials. An electric current is then induced in the area of the symbol and through the conductive materials. The electric current is used to generate heat in the conductive materials, wherein the heat causes the symbol to be fused to the article.

### BACKGROUND OF THE INVENTION

The present invention relates to the field of identification bar codes, readers, and scanners, and more particularly, is directed to a method and apparatus for reading bar code symbols.

With the widespread adoption and use of bar codes in recent years, the need for a method and apparatus for reliably reading such symbols has increased as well. This is especially so where such symbols are used in harsh environments and/or where the bar code has been applied under less than ideal circumstances.

The development of modern bar codes began in the 1940s in response to the food industry's need for a reliable and economical system for inventory control and for automatically reading product information at grocery store checkouts. The first patent to issue on such a system is believed to be U.S. Pat. No. 2,612,994 entitled Classifying Apparatus and Method and which issued on Oct. 7, 1952.

Although the coding system used in the '994 patent relied on a series of concentric circles to encode the identification information, the original coding approach developed by the inventors was a series of narrow and wide vertical lines much like present day bar code systems. Early implementations of the concentric circle approach proved unreliable however, as the circles were difficult to print without smearing. Smeared circles introduced reading errors when scanned and thus were unacceptable. The use of vertical bars eliminated the smearing problem and associated scanning errors.

Since the adoption of the Universal Product Code (UPC) in 1973, bar codes have proliferated to virtually all areas of article and product identification. Bar codes are now widely recognized as an economical and reliable identification system.

Over the years, a number of different versions of the UPC bar code have been developed. Version A is one of the most popular and is illustrated in FIG. 1. The Version A format includes a plurality of spaced vertical bars 1 which form the bar code and a plurality of human readable digits which correspond to the bar code, i.e., “0 25528 43507 3” as indicted by reference number 2.

As shown in FIG. 1, the code is divided into 12 digits, with the first digit 3 being usually a “0”. The next five digits 4 are assigned to the product manufacturer by the Uniform Code Council and thus serve to identify the manufacturer. Accordingly, all of the bar codes for the same manufacturer will have these same five digits. The next five digits 5 represent the item identification code given to a particular product by the manufacture. Thus, 99,999 products can be uniquely identified. The final twelfth digit 6 is a check digit which is used by the bar code scanner to confirm the accuracy of the scan.

Each of the human readable digits is encoded into the code using a two-part binary coding system as indicated in the table below:

Code Key

| Digit | Left | Right |
|---|---|---|
| Value | Binary Code | Binary Code |
| 0 | 0001101 | 1110010 |
| 1 | 0011001 | 1100110 |
| 2 | 0010011 | 1101100 |
| 3 | 0111101 | 1000010 |
| 4 | 0100011 | 1011100 |
| 5 | 0110001 | 1001110 |
| 6 | 0101111 | 1010000 |
| 7 | 0111011 | 1000100 |
| 8 | 0110111 | 1001000 |
| 9 | 0001011 | 1110100 |

Each A1″ in the key code is represented by a black bar 7 as illustrated in FIG. 1 and each A0″ in the key code is represented by a white line or space 8. There is a center code of four lines (binary digits 01010) which bisect the bar code. On the left side of the bar code, the Left Binary Code digits from the above table are used and on the right side of the bar code, the Right Binary Code digits from the table are used. This mirror image coding technique allows the scanner to read the number code in either direction. Start and stop codes are used by the scanner to set the width of the binary digits within the bar code symbol. The scanner also uses the check digit to calculate a check sum as is know in the art. If the correct check sum is not calculated, the bar code read is rejected.

FIG. 2 is a further illustration of a typical UPC bar code with its constituent parts labeled.

As a testament to the popularity of bar code use, the UPC bar code is scheduled to be phased out by the year 2005 because its 12-digit length will no longer be sufficient to handle the demand for bar codes. In its place, the United States is expected to adopt a version of the European Article Numbering (EAN) system. The EAN bar code system has thirteen digits and can thus accommodate substantially more product identifications than the UPC.

The traditional printed bar code system continues to serve its original purpose of grocery store inventory control and check out very well. Bar codes formed of conventional two-dimensional printed bars work well where the article to be labeled is not subject to a harsh environment and the bar code label is not likely to be rubbed off or smeared over so that it cannot be read.

The food industry serves as an ideal environment for conventional bar codes. Bar codes used for food labeling are unlikely to be subjected to harsh environments due to the inherent need to prevent adulteration and damage to the food package. Thus, the bar code label is not likely to become damaged or unreadable.

The bar code system has in some respects however, become the victim of its own success. Today, attempts are being made to use bar codes in many environments in which a conventional printed two-dimensional bar code, such as the one used for food products, cannot be used. One such environment is the tire manufacturing industry.

U.S. Pat. No. 5,160,383 assigned to Goodyear Tire & Rubber discloses one example of the use of a bar code labeling technique in the tire industry. According to the patent, it is important that a tire label be highly durable so that it may still be read after many years of tire service and multiple retreadings. The patent also notes that serial numbers can be molded into tire sidewalls but that doing so is labor intensive and costly. Thus, Goodyear sought to improve upon conventional tire labeling systems by attaching an identification label to the rubber inter lining of an uncured tire. The label is made of two materials which are co-curable with the rubber of the tire. The tire is then cured using a conventional curing process which results in the label becoming permanently affixed to the inside of the tire.

Goodyear also is the assignee of U.S. Pat. No. 4,625,101 which discloses a method of molding a bar code configuration onto the sidewall of a tire. The bar code configuration has a plurality of sloped reflective surfaces which allow more flexibility in locating the bar code scanner without adversely effecting the accuracy of the scan. A bar code plate mold insert is used to mold the bar code configuration into the sidewall of the tire during the vulcanization process.

Another technique for labeling a tire is disclosed in U.S. Pat. No. 4,941,522 assigned to the Yokohama Rubber Company. The Yokohama approach involves an improved bar code plate mold insert which is also used to mold a bar code into a side wall of the tire during the vulcanization process. The improved plate is said to solve the problem of deterioration of the tire's resistance to weather in the area of the molded bar code.

Ideally, an identification bar code will be embedded into the article during the manufacturing process. Doing so, avoids the possibility of misidentification, i.e., the wrong bar code being applied, in a subsequent labeling step.

In order to improve the durability and readability of bar codes in harsh environments such as casting, a three-dimensional bar code construction was developed. An end view of a portion of such a bar code is illustrated in FIG. 3. Each bar has a width 30 and a height 31. The distinguishing feature of this type of bar code is its height 31. The bar code is scanned by a three-dimensional bar code reader which detects the presence or absence of a bar based on its height rather than its contrast as a conventional two dimensional bar code reader does. Thus, a three dimensional bar code can be read when no color contrast is available. Contrast, for reading purposes, is supplied by the profile of the data cell relative to the surrounding surface, and the direction of the lighting of the reading device. Light beams are sometimes recaptured, or directed in such a way to cast ‘shadows,’ or are directed to reflect away from the reading device. Three dimensional bar code readers are known in the art, and include the readers formerly manufactured by the Sensis Corporation (laser illuminated), and more readily available optical readers manufactured by such companies as Cognex Corporation, DVT, Inc., Robotic Vision Systems, Inc., and others. Most of the reading systems now capable of deciphering three dimensional, or Bumpy, bar codes evolved out of vision inspection systems, and have made their appearance in the marketplace relatively recently.

Three dimensional bar codes have proved to be a much better choice in some situations as they will not easily rub off, smear, peel, or vanish because bonding strengths, in essence, equate to a direct part marking system, or in case of molding processes, are, in fact, simply contours in the part itself.

Three-dimensional bar codes can be painted over or the article on which they are placed can be subjected to various treatment processes without the readability of the bar code being adversely affected. Three-dimensional bar codes are also useful where a traditional printed bar code label will not adhere to the surface of the article to be labeled.

The use of bar codes during manufacture for work-in-process tracking, inventory control, work piece routing, etc., has become a valuable tool. Embedding, or molding, the bar code into the article during its manufacture is the most expedient and cost effective identification system. However, due to the harsh environments in which many manufacturing processes occur embedding or molding a bar code into a manufactured article can present many challenges. These challenges involve overcoming the ill effects caused by the very high temperatures, abrasive and corrosive treatments and processes, and pressures that are present in, e.g., cast and molding processes, forging, machining, and other manufacturing or remanufacturing processes. In addition to OEM manufacturing there are millions and millions of parts, often safety critical, that are currently in use which need traceability, and in some instances, require traceability by reason of governmental regulation.

Applicant's U.S. Pat. Nos. 6,666,255 and 6,666,257, both entitled “Bar Code Stencil And Method Of Use” describe a bar code stencil and method of using the stencil to easily and quickly mark vertically any article with a three dimensional bar code. While the teachings of these patents represent a major advancement in the art with respect to the formation of a bar code on an article to be tracked, the art remains deficient with respect subsequent reading of the bar code, especially in under harsh conditions.

Thus, there is a need in the art for a method and apparatus for reliably reading a formed bar code under a variety of reading conditions and bar code integrity.

### SUMMARY OF THE INVENTION

Accordingly, it is an objective of the present invention to obviate the above-noted shortcomings and disadvantages of prior art methods and apparatus for reading a bar code marking.

It is a further objective of the present invention to provide an improved method and apparatus for bar code reading that is more reliable and cost effective than conventional methods.

It is a still further objective of the present invention to provide an improved method and apparatus for bar code reading that is economical to implement and simple in operation.

It is a still further objective of the present invention to provide an improved method and apparatus for bar code reading that can be used in harsh environments.

The method and apparatus of the present invention relates to permanent machine-readable bar code data symbols applied to or embedded into a part surface for traceability and tracking purposes. These direct-part marks are most desirable when they are non-intrusive to the part and remain readable throughout the products normal life cycle. The marking processes does not detrimentally effect the functional performance, reliability, or durability of the product.

Readability is also of primary importance and is readily achievable with the method and apparatus of the present invention. Most prior art barcode scanners requires some level of contrast to decode the mark. The contrast required is typically generated through the method used to make the mark or data symbol, such as black and white printing. In the case of no contrast, it can be created through the use of directional lighting to create shadows that camera or scanner based decoders can see. Camera based decoders can also decode no contrast barcodes through reading reflected laser light.

There are several types of thermal spray methods known in the prior art that can provide a machine readable data symbol of sufficient contrast and durability. Most are applicable to retrofit marking of, e.g., steel aircraft components, as the part will typically need to remain below 250 degrees F. However, methods such as spray & fusion, are applicable to retrofit marking but would yield the most durable and chemical resistant mark. These methods are not applicable because they require the mark area to be elevated to a 1,800 degree F. fusion temperature after spraying or pasting through a stencil to fuse the applied material to the part. The part would thereafter typically require a heat treat after the fusion process for strain relief.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIGS. 1 and 2 are illustrations of a UPC bar code; and

FIG. 3 is a block diagram of the induction fusion device of the present invention.

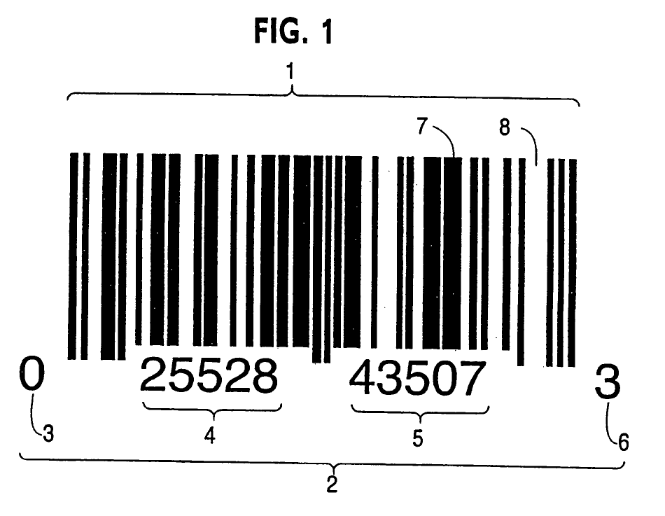

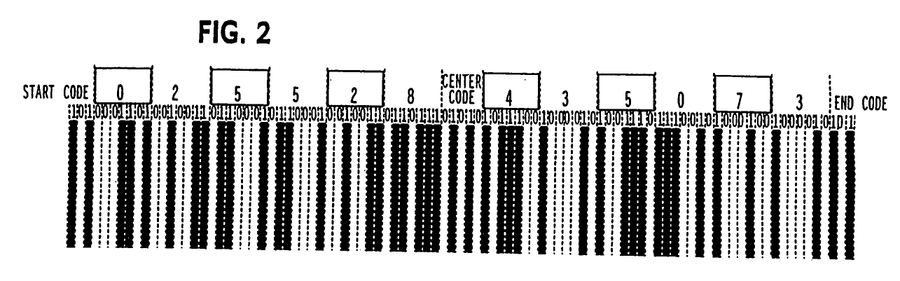

### DESCRIPTION OF THE PREFERRED EMBODIMENT

A preferred embodiment of the present invention will now be described with further reference to accompanying drawings.

In accordance with the present invention, hand held current induction heating technology is employed to fuse spray and fusion marks to the substrate with no metallurgical impact. Test have shown that when fusing a mark with an induction heater, the parent material fusion temperature of 1,800 degrees only penetrates 0.040 inches or less into the parent material alleviating any metallurgical concerns.

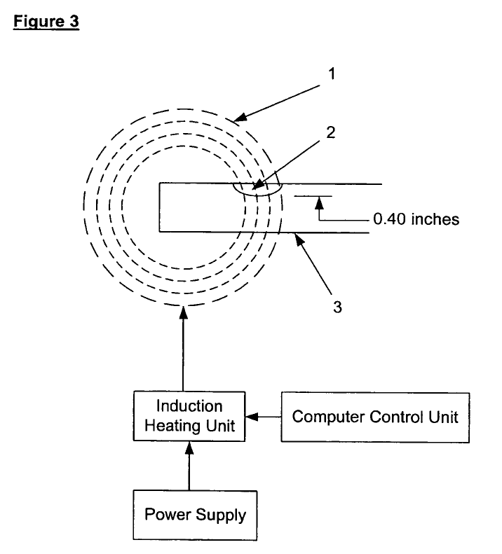

The apparatus of the present invention is illustrated in FIG. 3. As is known in the art, any material that conducts electricity can be headed by inducing current into the material. The apparatus of the invention includes an Induction Heating Unit coupled to a Power Supply and a Computer Control Unit. As is known in the art, the Induction Heating Unit generated a series of electromagnetic waves 1 which induces heat in any metallic object that intersects the waves. When a mark 2 made on the substrate of a material 3, electromagnetic waves 1 create a fusion temperature of 1,800 degrees to thereby fuse the mark to the substrate. As pointed out above, this temperature penetrates the substrate to a depth of no more than 0.40 inches.

The induction heating apparatus of the present invention can easily be reduced to a hand held device for portability and mobile applications.

The resulting symbols or marks after fusion have a data cell hardness of 59 to 60 C scale of the Rockwell Hardness and data cell to substrate bond strengths near 30,000 PSI and can be accomplished in less than a minute. This strength far exceeds the bond strengths of other marking methods and most thermal sprayed adhesive values.

The hand held current inducing heating apparatus of the present invention may also be used to provide a method to read a data symbol or bar code positioned under several layers of paint or bonded to the back side of a non conductive material or article. Studies have shown that iron loaded sheet polyurethane material formed into a data symbol provides enough temperature change when placed in the magnetic flux of a induction heating coil to be allowed a thermal imaging camera to retrieve an image of sufficient contrasting and quality to be decoded.

Applicant has also found that a lacer can be used as an effective way to read a data symbol or bar code. The lacer relies on shadows cast by the three dimensional symbol or bar code. These shadows are then used to decode the symbol.

It should be obvious from the above-discussed apparatus embodiment that numerous other variations and modifications of the apparatus of this invention are possible, and such will readily occur to those skilled in the art. Accordingly, the scope of this invention is not to be limited to the embodiment disclosed, but is to include any such embodiments as may be encompassed within the scope of the claims appended hereto.

1. A method of making a machine readable data symbol marking on an article to be marked, said method having the steps of:
marking said symbol on said article using a stain, said stain including particles of conductive materials;
inducing an electric current into said article in the area of said symbol and through said conductive materials;
using said electric current to generate heat in said conductive materials, wherein said heat causes said symbol to be fused to said article.

2. The method of claim 1, wherein said step of marking said symbol on said article includes the step of using a stencil to form said symbol.

3. The method of claim 1, wherein said step of marking said symbol on said article includes the step of applying said symbol directly onto said article.

4. The method of claim 1, wherein said step of marking said symbol on said article includes the step of applying said symbol in the form of a powder onto said article.

5. The method of claim 1, wherein said step of marking said symbol on said article includes the step of applying said symbol in the form of a paste onto said article.

6. The method of claim 1, wherein said step of marking said symbol on said article includes the step of spraying said symbol onto said article.

7. The method of claim 1, wherein said step of marking said symbol on said article includes the step of brushing said symbol directly onto said article.

8. The method of claim 1, wherein said step of marking said symbol on said article includes the step of applying a negative image of said symbol onto said article.

9. The method of claim 1, wherein said step of marking said symbol on said article includes the step of applying a positive image of said symbol onto said article.

10-12. (canceled)
